(19) United States
(12) Patent Application Publication
(10) Pub. No.: US 2009/0199776 A1
(43) Pub. Date: Aug. 13, 2009

(54) DISPOSABLE WATER CONTAINER/BOWL FOR PETS

(76) Inventors: Laurie McDermott Alexander, Kennesaw, GA (US); Joseph Scarlett Alexander, JR., Kennesaw, GA (US)

Correspondence Address: GEORGE R. REARDON, 3356 STATION COURT, LAWRENCVILLE, GA, 30044, US

(21) Appl. No.: 12/365,163

(22) Filed: Feb. 3, 2009

Related U.S. Application Data
(60) Provisional application No. 61/063,993, filed on Feb. 8, 2008.

(51) Int. Cl. A01K 7/00; A01K 29/00; A01K 5/01

(52) U.S. Cl. 119/61.56; 119/72; 294/1.3; 119/61.5

(57) ABSTRACT

The technology described herein provides a portable bagged water container having an embedded reinforcement rim to hold drinking water for a pet. In one embodiment, the technology includes portable fluid container for a pet having a fluid bag configured to contain a potable fluid, to be prefilled with the potable fluid and stored and sealed for subsequent consumption by a pet for hydration and an attachment device for attaching the fluid bag to the pet. The fluid bag is sealed in an original state. The fluid bag includes a perforation tear line from which to tear open a top edge of the bag and provide access to a resealable zip closure to open and access the prefilled fluid and to enable the pet to consume the fluid within the bag.

### CROSS-REFERENCE TO RELATED APPLICATION(S)

The present non-provisional patent application claims the benefit of priority of U.S. Provisional Patent Application No. 61/063,993, which is entitled “DISPOSABLE WATER CONTAINER/BOWL FOR PETS”, which was filed on Feb. 8, 2008, and which is incorporated in full by reference herein.

### FIELD OF THE INVENTION

The technology described herein relates generally to sealed water containers from which the contained water can be consumed. More specifically, this technology relates to a bagged water container having an embedded reinforcement rim to hold drinking water for a pet that upon initial use a seal is broken and a zip closure opened to enable access to the contained water, that can be reused and resealed multiple times with a zip closure, and that is an animal waste bag at the end of its use as a water container.

### BACKGROUND OF THE INVENTION

Pets are known to accompany their owners on various trips, outdoor activities, fitness exercises, and the like. By way of example, a dog often enjoys accompanying its owner while he or she is walking, jogging, or bicycling. It is imperative for not only the owner, but also the pet, to maintain adequate hydration during such activities.

Related patents known in the art include the following: U.S. Pat. No. 6,016,772, issued to Noyes on Jan. 25, 2000, discloses a multiple function collar/harness/belt/leash having a collapsible cup/bowl portion. U.S. Pat. No. 6,516,748, issued to Jackson on Feb. 11, 2003, discloses a combination pet collar and water bowl. U.S. Published Patent application No. 2006/0065201 filed by Cogliano et al. and published on Mar. 30, 2006, discloses a combination water reservoir and dog collar. U.S. Published Patent application No. 2007/0163507 filed by Lynch and published on Jul. 19, 2007, discloses a portable pet bowl.

The foregoing patent and other information reflect the state of the art of which the inventor is aware and are tendered with a view toward discharging the inventor's acknowledged duty of candor in disclosing information that may be pertinent to the patentability of the technology described herein. It is respectfully stipulated, however, that the foregoing patent and other information do not teach or render obvious, singly or when considered in combination, the inventor's claimed invention.

### BRIEF SUMMARY OF THE INVENTION

In various exemplary embodiments, the technology described herein provides a bagged water container having an embedded reinforcement rim to hold drinking water for a pet.

In one exemplary embodiment, the technology described herein provides a portable fluid container for a pet. The container includes a fluid bag configured to contain a potable fluid, such as water, to be prefilled with the potable fluid and stored and sealed for subsequent consumption by a pet for hydration. The fluid bag is sealed in an original state. The fluid bag includes a perforation tear line from which to tear open a top edge of the bag and provide access to a resealable zip closure to open and access the prefilled fluid and to enable the pet to consume the fluid within the bag. The portable fluid container includes an attachment device for attaching the fluid bag to the pet.

The portable fluid container includes a reinforcement rim disposed with the fluid bag to provide rigidity and structural integrity to the bag such that it contains the potable fluid in an upright, contained manner consumable by the pet.

The attachment device can further include at least one strap for connectivity to a pet collar, wherein the fluid bag is configured to be attached to a pet collar and worn around the neck of the pet. Alternatively, the attachment device can further include at least one integral loop disposed on the fluid bag for connectivity to a pet collar. Attachments means can include the use of fasteners such as hook-and-loop fasteners and snaps. The fluid bag also is configured for attachment to a leash.

The portable fluid container is configured to be resealed when the potable fluid contained within is not consumed by the pet. Alternatively, upon consumption of the fluid contained within the bag, the bag is configured to be used to pick up a waste product of the pet and resealed for disposal.

In another exemplary embodiment, the technology described herein provides a portable combination water container and bowl for a pet includes a sealed, water-filled bag to be stored and sealed for subsequent consumption by a pet for hydration, an attachment device for attaching the bag, and a reinforcement rim disposed with the bag to provide rigidity and structural integrity to the bag such that it contains the water in an upright, contained manner as a bowl to facilitate ease in consumption of the water by the pet.

The bag is sealed in an original state. The bag includes a perforation tear line from which to tear open a top edge of the sealed bag and provide access to a resealable zip closure to open and access the prefilled water and to enable the pet to consume the water within the bag.

The bag is configured to be resealed when the water contained within is not consumed by the pet. Upon consumption of the fluid contained within the bag, the bag is configured to be used to pick up a waste product of the pet and resealed for disposal. The combination water container and bowl for a pet is configured for attachment to a leash.

In yet another exemplary embodiment, the technology described herein provides a method for hydrating a pet. The method includes utilizing a fluid bag configured to contain a potable fluid, to be prefilled with the potable fluid and stored and sealed for subsequent consumption by a pet for hydration and selectively attaching the fluid bag to the pet for transport.

The fluid bag is sealed in an original state. The fluid bag includes a perforation tear line from which to tear open a top edge of the bag and provide access to a resealable zip closure to open and access the prefilled fluid and to enable the pet to consume the fluid within the bag.

The method also includes selectively removing the fluid bag from the pet, tearing open the fluid bag along the perforation tear line to open the top edge of the bag, separating the zip closure to open the fluid bag and make the contained potable fluid available to the pet, and presenting the potable fluid to the pet.

The method also includes resealing the zip closure of the fluid bag when the fluid contained within has not been fully consumed by the pet and selectively reattaching the fluid bag to the pet for transport.

The method also includes utilizing the fluid bag, when the fluid contained within has been fully consumed by the pet, for waste disposal, picking up a waste product of the pet with the emptied fluid bag, and resealing the zip closure of the fluid bag for disposal of the fluid bag.

The method can also include utilizing a fluid bag further comprising a reinforcement rim disposed with the fluid bag to provide rigidity and structural integrity to the bag such that it contains the potable fluid in an upright, contained manner consumable by the pet and presenting the fluid bag to the pet in a bowl-like manner as the fluid bag is supported by the reinforcement rim.

There has thus been outlined, rather broadly, the more important features of the technology in order that the detailed description thereof that follows may be better understood, and in order that the present contribution to the art may be better appreciated. There are additional features of the technology that will be described hereinafter and which will form the subject matter of the claims appended hereto. In this respect, before explaining at least one embodiment of the technology in detail, it is to be understood that the invention is not limited in its application to the details of construction and to the arrangements of the components set forth in the following description or illustrated in the drawings. The technology described herein is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the technology described herein.

Further objects and advantages of the technology described herein will be apparent from the following detailed description of a presently preferred embodiment which is illustrated schematically in the accompanying drawings.

### BRIEF DESCRIPTION OF THE DRAWINGS

The technology described herein is illustrated with reference to the various drawings, in which like reference numbers denote like device components and/or method steps, respectively, and in which:

FIG. 1 is a front view of a disposable water container for pets, illustrating, in particular, the sealed water contained within the container, the sealed zip closure, and an attachment means, according to an embodiment of the technology described herein;

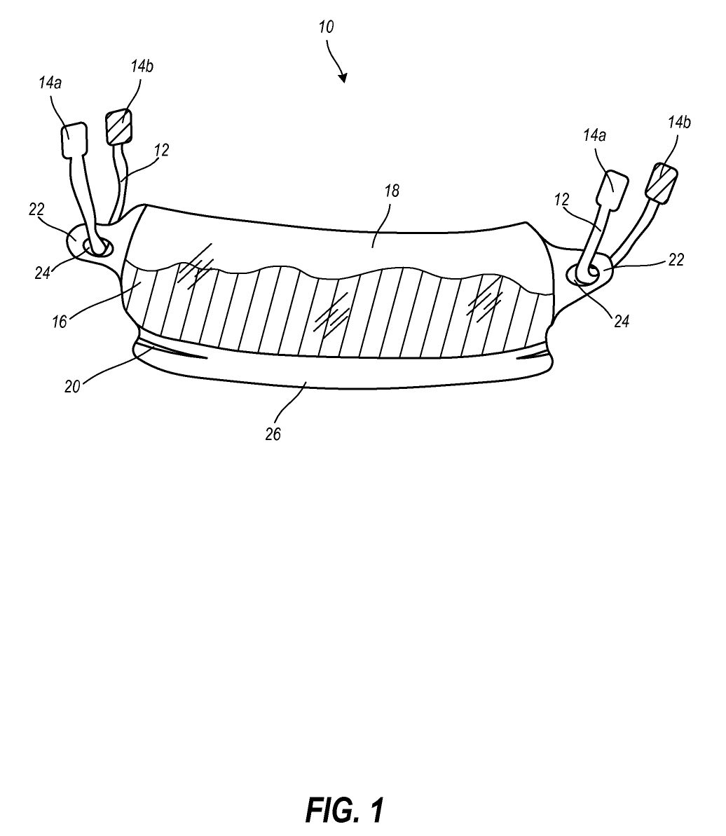

FIG. 2 is a front view of the disposable water container for pets depicted in FIG. 1, shown in use on a dog, according to an embodiment of the technology described herein;

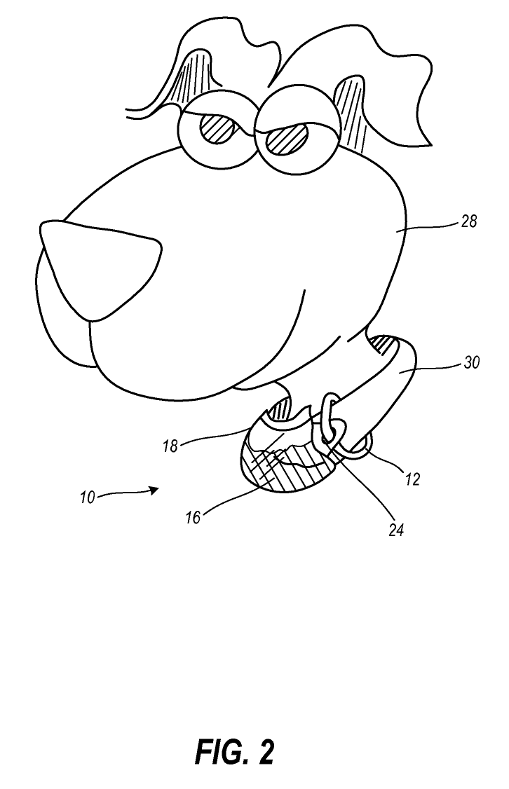

FIG. 3 is a top view of the disposable water container for pets depicted in FIG. 1, shown in use secured to a pet collar, and illustrating, in particular, the embedded reinforcement rim, according to an embodiment of the technology described herein;

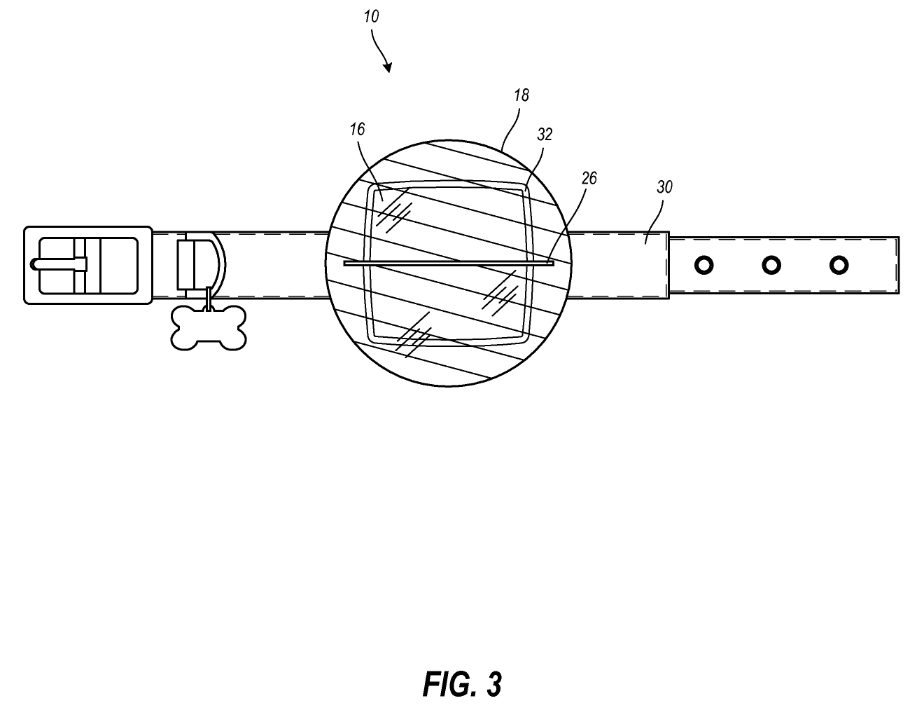

FIG. 4 is a side view of the disposable water container for pets depicted in FIG. 1, illustrating, in particular, an integrated loop utilized to slide over a pet collar or leash, according to an embodiment of the technology described herein;

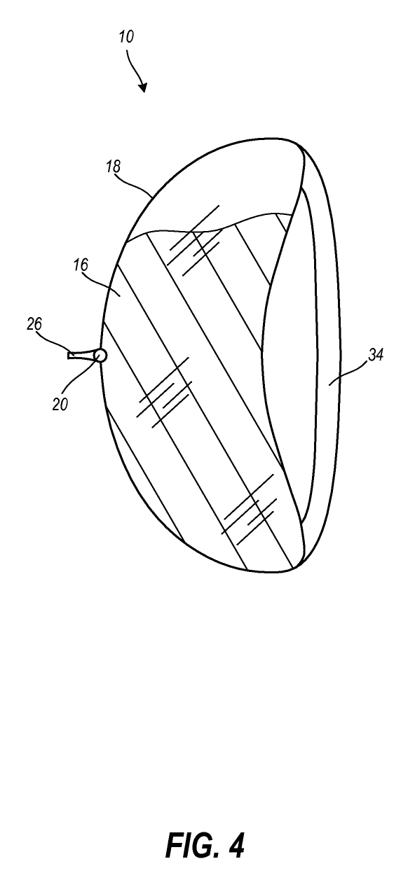

FIG. 5 is a top perspective view of the disposable water container for pets depicted in FIG. 1 illustrating, in particular the container in a sealed, unopened state;

FIG. 6 is a top perspective view of the disposable water container for pets depicted in FIG. 1 illustrating, in particular the container in an open, unsealed state;

FIG. 7 is a bottom view of the disposable water container for pets depicted in FIG. 1, shown in use prior to being secured to a pet collar, and illustrating, in particular, the use of snaps as an attachment means, according to an embodiment of the technology described herein;

FIG. 8 is a close-up view of the seal and zip closure of the disposable water container for pets depicted in FIG. 1, according to an embodiment of the technology described herein; and

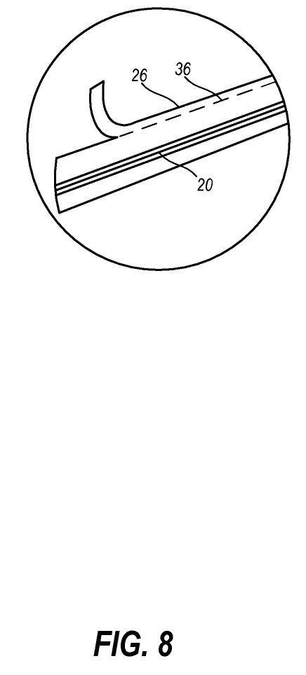

FIG. 9 is a top view of the disposable water container for pets depicted in FIG. 1.

### DETAILED DESCRIPTION OF THE INVENTION

Before describing the disclosed embodiments of this technology in detail, it is to be understood that the technology is not limited in its application to the details of the particular arrangement shown here since the technology described is capable of other embodiments. Also, the terminology used herein is for the purpose of description and not of limitation.

In various exemplary embodiments, the technology described herein provides a bagged water container having an embedded reinforcement rim to hold drinking water for a pet. Pets are known to accompany their owners on various trips, outdoor activities, fitness exercises, and the like. By way of example, a dog often enjoys accompanying its owner while he or she is walking, jogging, or bicycling. It is imperative for not only the owner, but also the pet, to maintain adequate hydration during such activities. This technology provides for a portable device that already contains a fluid to hydrate a pet.

Referring now to the Figures, a container 10 is shown. In one embodiment, the container 10 is a portable fluid container for a pet. In at least one alternative embodiment, the container 10 is a portable combination water container and bowl for a pet. The container 10 includes fluid bag 18 configured to contain a potable fluid 16, to be prefilled with the potable fluid 16 and stored and sealed for subsequent transport and consumption by a pet 28 for hydration. The fluid 16 stored and sealed within the fluid bag 18 is a potable fluid such as spring water, or the like. The fluid 16 contained in the fluid bag 18 can be varied to accommodate varied consumer and pet interests. The fluid bag 18 can be manufactured from a plastic, waterproof material. In a preferred embodiment, the fluid bag 18 is manufactured from a biodegradable, environmentally-friendly material. The container 10 can be sold in a retail environment individually or packaged in multiples.

The fluid bag 18 is sealed in its original state and contains a prefilled fluid 16, such as water. The fluid bag 18 can include a perforation tear line 36 from which to tear open a top edge 26 of the bag 18 and provide access to a resealable zip closure 20 to open and access the prefilled fluid 16 and to enable the pet 28 to consume the fluid 16 within the bag 18.

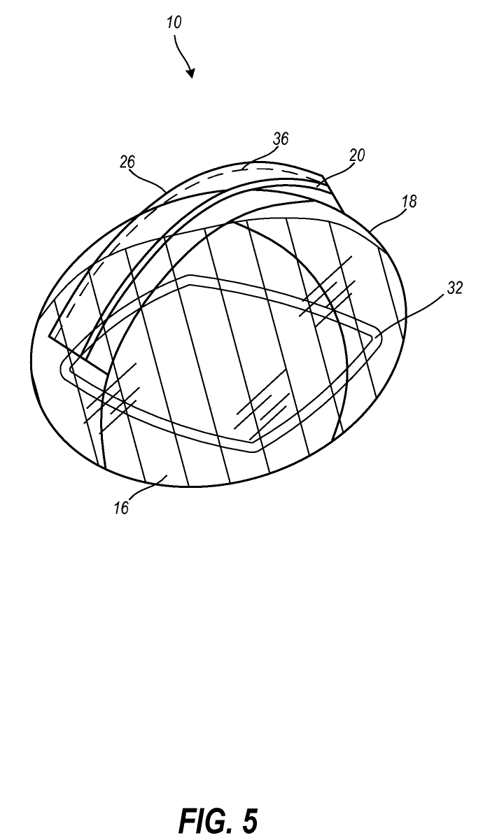

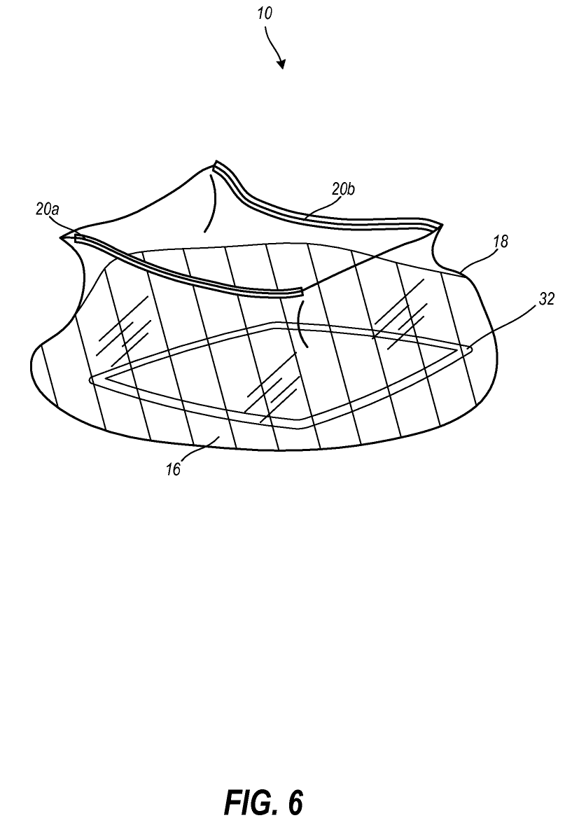

The resealable zip closure 20 can be opened and closed selectively by the user. As depicted specifically in FIGS. 5 and 6, the resealable zip closure 20 is shown closed (in FIG. 5) and opened (in FIG. 6), with zipper sides 20a, 20b shown separated one from another. The zip closure 20 can be resealed when the contained water is not fully consumed. Additionally, when an emptied bag 18 is subsequently used to collect pet waste, the bag 18 can be resealed with the zip closure 20 to discard.

The container 10 includes various means of attachment. In various embodiments, the container 10 can be carried as is, attached to a collar 30 to be worn around the neck by a pet 28, attached to a leash (not shown), and so forth. Other means of attachment can be utilized to secure the container 10 to a person, pet 28, or other object.

It at least one embodiment, the fluid bag 18 further includes at least one aperture 24 located on a tab 22 on an edge of the bag 18 and through which an attachment strap 12 is placed. The tab 22 is external to the fluid holding section of the bag 18 and does not interfere with the ability of the bag 18 to contain and seal a fluid 16. The attachment strap 12 is utilized to attach the container 10 to a person, pet 28, or object.

The ends of the attachment strap 12 can include fasteners 14a, 14b. For example, fasteners 14a, 14b can be hook-and-loop fasteners. Alternatively, fasteners 14a, 14b can be snaps. By way of example, the attachment strap 12 can be utilized for connectivity to a pet collar 30 and worn around the neck of the pet 28.

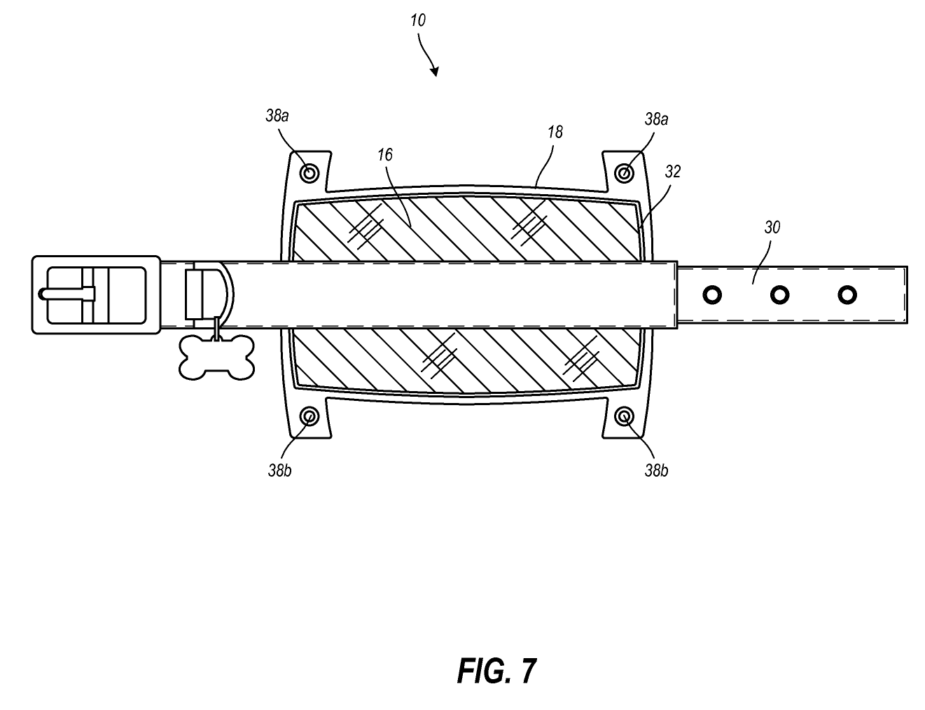

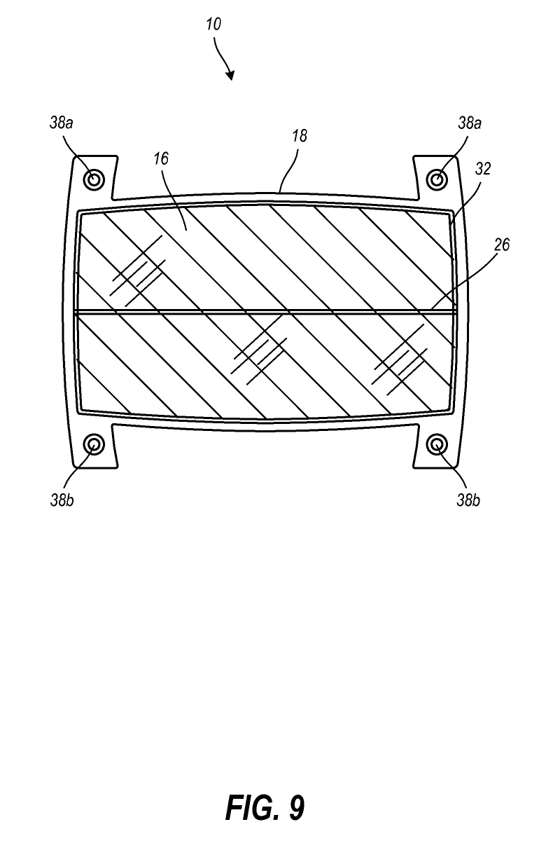

In yet another alternative embodiment, the container 10 includes snaps, or other integral fasteners, integral to the fluid bag 18. As depicted specifically in FIGS. 7 and 9, snap components 38a, 38b can snap together one to another in pairs to secure the bag 18 to a pet collar 30, leash, or the like.

The container 10 includes a reinforcement rim 32 disposed with the fluid bag 18 to provide rigidity and structural integrity to the bag 18 such that it contains the potable fluid 16 in an upright, contained manner as a bowl to facilitate ease in consumption of the potable fluid 16 by the pet 28.

In at least one embodiment, the container 10 further includes at least one integral loop 34 generally disposed on a base side of the fluid bag 18. The loop 34 provides a means of connectivity to attach the container 10 to a pet collar 30, or the like. More than one loop 34 can be utilized on the fluid bag 18. The loop 34 can be made of the same material as the fluid bag 18 and can be integrally formed with the fluid bag 18.

In operation, and by way of example, a pet can be hydrated with the following methods steps: utilizing a fluid bag 18 configured to contain a potable fluid 16, to be prefilled with the potable fluid 16 and stored and sealed for subsequent consumption by a pet 28 for hydration and selectively attaching the fluid bag 18 to the pet 28 for transport; selectively removing the fluid bag 18 from the pet 28, tearing open the fluid bag 18 along the perforation tear line 36 to open the top edge 26 of the bag 18, separating the zip closure 20 to open the fluid bag 18 and make the contained potable fluid 16 available to the pet 28, and presenting the potable fluid 16 to the pet 28; resealing the zip closure 20 of the fluid bag 18 when the fluid 16 contained within has not been fully consumed by the pet 28 and selectively reattaching the fluid bag 18 to the pet 28 for transport; utilizing the fluid bag 18, when the fluid 16 contained within has been fully consumed by the pet 28, for waste disposal, picking up a waste product of the pet with the emptied fluid bag 18, and resealing the zip closure 20 of the fluid bag 18 for disposal of the fluid bag 18; and utilizing a fluid bag 18 further containing a reinforcement rim 32 disposed within the fluid bag 18 to provide rigidity and structural integrity to the bag 18 such that it contains the potable fluid 16 in an upright, contained manner consumable by the pet 28 and presenting the fluid bag 18 to the pet 28 in a bowl-like manner as the fluid bag 18 is supported by the reinforcement rim 32.

Although this technology has been illustrated and described herein with reference to preferred embodiments and specific examples thereof, it will be readily apparent to those of ordinary skill in the art that other embodiments and examples can perform similar functions and/or achieve like results. All such equivalent embodiments and examples are within the spirit and scope of the invention and are intended to be covered by the following claims.

What is claimed is:

1. A portable fluid container for a pet, the container comprising:
a fluid bag, the fluid bag configured to contain a potable fluid, to be prefilled with the potable fluid and stored and sealed for subsequent consumption by a pet for hydration; wherein the fluid bag is sealed in an original state; and wherein the fluid bag comprises a perforation tear line from which to tear open a top edge of the bag and provide access to a resealable zip closure to open and access the prefilled fluid and to enable the pet to consume the fluid within the bag; and
an attachment device for attaching the fluid bag to the pet.

2. The fluid container of claim 1, further comprising:
a reinforcement rim disposed with the fluid bag to provide rigidity and structural integrity to the bag such that it contains the potable fluid in an upright, contained manner consumable by the pet.

3. The fluid container of claim 1, wherein the attachment device further comprises an at least one strap for connectivity to a pet collar and wherein the fluid bag is configured to be attached to a pet collar and worn around the neck of the pet.

4. The fluid container of claim 1, wherein the attachment device further comprises an at least one integral loop disposed on the fluid bag for connectivity to a pet collar and wherein the fluid bag is configured to be attached to a pet collar and worn around the neck of the pet.

5. The fluid container of claim 1, wherein the attachment device further comprises an at least one set of fasteners.

6. The fluid container of claim 5, wherein the at least one set of fasteners comprises hook and loop fasteners.

7. The fluid container of claim 5, wherein the at least one set of fasteners comprises snaps.

8. The fluid container of claim 1, wherein the potable fluid is water.

9. The fluid container of claim 1, wherein the fluid bag is configured to be resealed when the potable fluid contained within is not consumed by the pet.

10. The fluid container of claim 1, wherein, upon consumption of the fluid contained within the bag, the bag is configured to be used to pick up a waste product of the pet and resealed for disposal.

11. The fluid container of claim 1, wherein the fluid bag is configured for attachment to a leash.

12. A portable combination water container and bowl for a pet, comprising:
a sealed, water-filled bag to be stored and sealed for subsequent consumption by a pet for hydration, wherein the bag is sealed in an original state, and wherein the bag comprises a perforation tear line from which to tear open a top edge of the sealed bag and provide access to a resealable zip closure to open and access the prefilled water and to enable the pet to consume the water within the bag;
an attachment device for attaching the bag; and
a reinforcement rim disposed with the bag to provide rigidity and structural integrity to the bag such that it contains the water in an upright, contained manner as a bowl to facilitate ease in consumption of the water by the pet.

13. The portable combination water container and bowl for a pet of claim 12, wherein the bag is configured to be resealed when the water contained within is not consumed by the pet.

14. The portable combination water container and bowl for a pet of claim 12, wherein, upon consumption of the fluid contained within the bag, the bag is configured to be used to pick up a waste product of the pet and resealed for disposal.

15. The portable combination water container and bowl for a pet of claim 12, wherein the combination water container and bowl for a pet is configured for attachment to a leash.

16. A method for hydrating a pet, the method comprising:
utilizing a fluid bag, the fluid bag configured to contain a potable fluid, to be prefilled with the potable fluid and stored and sealed for subsequent consumption by a pet for hydration; wherein the fluid bag is sealed in an original state; and wherein the fluid bag comprises a perforation tear line from which to tear open a top edge of the bag and provide access to a resealable zip closure to open and access the prefilled fluid and to enable the pet to consume the fluid within the bag; and
selectively attaching the fluid bag to the pet for transport.

17. The method of claim 16, further comprising:
selectively removing the fluid bag from the pet;
tearing open the fluid bag along the perforation tear line to open the top edge of the bag;
separating the zip closure to open the fluid bag and make the contained potable fluid available to the pet; and
presenting the potable fluid to the pet.

18. The method of claim 17, further comprising:
resealing the zip closure of the fluid bag when the fluid contained within has not been fully consumed by the pet; and
selectively reattaching the fluid bag to the pet for transport.

19. The method of claim 17, further comprising:
utilizing the fluid bag, when the fluid contained within has been fully consumed by the pet, for waste disposal;
picking up a waste product of the pet with the emptied fluid bag; and
resealing the zip closure of the fluid bag for disposal of the fluid bag.

20. The method of claim 16, further comprising:
utilizing a fluid bag further comprising a reinforcement rim disposed with the fluid bag to provide rigidity and structural integrity to the bag such that it contains the potable fluid in an upright, contained manner consumable by the pet; and
presenting the fluid bag to the pet in a bowl-like manner as the fluid bag is supported by the reinforcement rim.
